(19) United States
(12) Patent Application Publication
(10) Pub. No.: US 2005/0029198 A1
(43) Pub. Date: Feb. 10, 2005

(54) Heavy metals absorbent and method of use

(76) Inventors: Frederick Tepper, Sanford, FL (US); Leonid Kaledin, Port Orange, FL (US)

Correspondence Address: Allen, Dyer, Doppelt, Milbrath & Gilchrist, P.A., 255 South Orange Avenue, Suite 1401, Orlando, FL, 32801, US

(21) Appl. No.: 10/638,250

(22) Filed: Aug. 8, 2003

(51) Int. Cl. C02F 1/42

(52) U.S. Cl. 210/688

(57) ABSTRACT

A media for removal of heavy metals from an aqueous system comprising a mixture of nano alumina fibers and a ferric or manganic compound selected from the group consisting of hydroxides, oxyhydroxides, oxides and hydroxyoxides and mixtures thereof. The nano alumina is preferably produced by hydrothermal digestion of aluminum hydroxide, is treated with alkaline, followed by the addition of a ferric or manganic salt to form a gel like mass that is dried, heat treated, ground and sieved to form the sorbent. Alternatively a non-woven media is formed by adding mineral fiber such as microglass to the hydrothermal step. The resulting mulch is treated with alkaline and subsequently an iron and/or manganic compound, wet laid and dried to form the fibrous sorbent. Removal of heavy metals from the aqueous system is readily accomplished by contacting the aqueous system with the media until the heavy metal is substantially removed from the aqueous system.

### STATEMENT OF GOVERNMENTAL RIGHTS

The subject invention was made with support under a research project supported by the United States Environmental Protection Agency and during a Department of Energy Cooperative Research and Development (CRADA) Agreement (No. 99-USIC-MULTILAB-04). Accordingly, the government has certain rights in this invention.

### FIELD OF THE INVENTION

The subject invention pertains to the field of water purification, more particularly to the use of composite nano materials as filter media for absorption of heavy metals.

### BACKGROUND OF THE INVENTION

Arsenic is classified by the Environmental Protection Agency as a Class A carcinogen. It is the 20th most abundant element in the earth's crust and is common in many drinking water sources. The long-term effects of consuming water with naturally occurring high levels of arsenic have been the subject of numerous studies. It has been found that chronic arsenic poisoning can cause thickening and discoloration of the skin, cancers of the liver, kidney and skin, and loss of circulation in the extremities causing a gangrenous-like condition known as blackfoot disease. Excessive arsenic concentration exists in the drinking water of several U.S. communities as well as many wells. It is prevalent in the well water of a number of third world countries such as Bangladesh, where arsenic poisoning is projected to cost thousands of lives over the next decade while thousands of others are destined to suffer from hideous skin lesions.

Due to the toxic and carcinogenic nature of arsenic, the EPA has established a maximum acceptable concentration (“MAC”) of 10 ppb arsenic. This MAC is scheduled to be implemented by January 2006, thereby resulting in a reduction from the current MAC of 50 ppb. Other countries have also established similar limits on drinking water. The EPA estimates that approximately 13 million people in the U.S. will be impacted; principally, those served by small water treatment plants, as well as others using well water. Municipal water systems are required to be upgraded to deliver water to meet the new MAC. Most such systems are inadequate when the entry water exceeds the current 50 ppb MAC. The impact of this regulation on small utilities, (those having less than 10,000 customers) is significant due to the high costs for central treatment. Utilities, mostly in the Southwest, with high arsenic water content areas, are the most affected. In some areas, well water may have influent levels as high as 300 ppb, requiring removal technology sufficient to perform at this higher concentration as well.

Municipal water treatment methods that have the potential for removing arsenic include, for example, coagulation/filtration, reverse osmosis, nanofiltration as well as arsenic sorption by a variety of fixed bed sorbents. These sorbents include ion exchange resins, activated alumina, manganese greensand and granular iron hydroxide (“GFH”). Fixed bed adsorption is a preferred method for removing contaminants, particularly for small systems and low flow systems.

Residential point of entry (“POE”) or point of use (“POU”) systems will play a significant part in meeting the new standards. A POE purification system treats all water at the entry to a residence, while the POU is a filter mounted in the faucet used for potable water, which is only 1% of total water usage. In many cases it is more cost effective to install individual POU purification systems than to upgrade the municipal system. This holds true particularly for systems with fewer than 250 users. To meet EPA requirements such systems must be owned and maintained by the utility companies.

Fixed bed absorbers are preferred for POU applications over reverse osmosis because the latter is more expensive and generates arsenic enriched contaminated waste. This waste creates a potential disposal problem, whereas most fixed bed absorbers can be disposed of as solid waste while still meeting regulatory disposal standards. A secondary consideration is the individual health concern among homeowners that can result in installing units to further lower the levels of arsenic in the water to 3 ppb or less.

System performance and cost are paramount considerations in choosing an arsenic removal system. The system's marketability is enhanced if it can be certified to an EPA testing protocol. This provides prima facie evidence that the device meets EPA requirements. A target capacity for POU arsenic filters is 1000 gallons of water, which is projected to be sufficient for the drinking water for a family of four for six months. Challenge concentrations range from 50 ppb arsenic, typical of the concentration delivered from a municipal water treatment plant or 300 ppb, more typical of contaminated well water. The protocol requires that the filter perform either in slightly acidic (pH=6.5) or alkaline (pH=8.5) water and at a minimum of 1 gallon per minute flow rate. While the current protocol only addresses arsenic valence V (arsenate), arsenic III (arsenite) is present to a considerable extent in certain waters and is more difficult to remove than arsenic V. The arsenic V protocol requires challenging the filter in the presence of dissolved solids including silicate, fluoride and phosphate. These ions are utilized because many are interferants in arsenic absorption. A test protocol for As III is not yet available; however, one is expected to be developed during 2003.

For POE and POU, beds of activated alumina (AA), iron oxide or hydroxide or mixtures of iron and AA are preferred because of ease of handling and sludge-free operations. Ion exchange resins are not preferred because of their irreversible loss of performance due to the absorption of sulfate contaminant in the water. Activated alumina (AA) has a low arsenic capacity (about 0.3 mg As/g of AA). A key issue in choosing a sorbent is the particle's strength and resistance to attrition.

U.S. Pat. No. 6,200,482 to Winchester et al. describes an arsenic filtering media consisting essentially of calcined diatomite particles and between 5% and 30% by weight of ferric ions bonded to these particles. Canadian Patent 1,067,627 to Lutwick teaches a method and apparatus for the removal of arsenic from water by passing water over a porous support material that is impregnated with ferric hydroxide.

Clifford, D., et al. Arsenic Treatment Technology Demonstration, Final Report GC022-00-Z1054 to the Montana Water Resources Center, (Mar. 21, 2001), discloses the testing of different types of AA produced by Apyron, Alcan, Alcoa, and GFH. They found that Alcan and Apyron AA's when challenged with 40 ppb As(V) @pH 7.5 has a sorption capacity in the range from 0.43 to 0.58 mg As(V)/g. GFH adsorbent was found to be far superior by at least a factor of 3 to Apyron and Alcan AA's.

U.S. Pat. No. 6,342,191 to Kepner et al. describes a method of acid etching treatment of activated alumina (gamma form) that enhances the adsorption for arsenic and other species. This material is being sold (Apyron) as a POU filter for arsenic. The patent provides an example illustrating arsenic capacity (arsenic trioxide dissolved via nitric acid) of approximately 10 grams/kg at elevated (50 ppm) concentrations, however, no pH is specified.

U.S. Pat. No. 6,030,537 to Shaniuk et al. discloses an arsenic sorbent consisting of activated bauxite and aluminum trihydrate where the bauxite may contain iron. The equilibrium arsenic capacity is measured as 0.15 mg As/g when the arsenic concentration is 50 ppb As III. In a subsequent reference U.S. patent application 20030089665 to Shaniuk, arsenic capacity equilibrium is improved ten fold by the addition of iron hydroxide and a natural or synthetic filler material to increase porosity of the particle. No dynamic adsorption data are given.

Granular iron hydroxide (GFH), manufactured by GEH Wasserchemie GmbH & Co. Osnabruck, Germany and a granular ferric oxide sorbent (Bayer AG Bayoxide E-33) are currently commercialized as arsenic sorbents. GFH can absorb 4.5 mg As V/g sorbent when challenged at 21 ppb As V at a pH of 7.8. This capacity is approximately 3 times greater than AA. However, the cost of GFH is between $8-10/kg, roughly three times that of AA. GFH may not be as attractive for home applications because it loses its strength over time and columns are known to degrade and clog during use. In addition, both GFH and E-33 lose their absorption capacity with alkaline water. There are no published data available on the dynamic absorption performance of either sorbent when challenged by various arsenic III or V concentrations at various flow velocities.

Until it was recognized as being acutely toxic, hexavalent chromium was used in many industrial processes, resulting in contamination of the ground water. Chromium is the second most prevalent metal (lead being first) present at superfund sites. The MCL is 300 ppb chromium although Environmental Protection Administration has set the (Maximum Contaminant Level Goals “MCLG”) for chromium at 0.1 parts per million (“ppm”). This level is set because given present technology and resources, the EPA believes it is the lowest level to which water systems can reasonably be required to remove the contaminant should it be present in drinking water. There is a strong desire in California and other states where there are wells contaminated with chromate to lower the standard even further. Chromate ground water contamination in California has become the subject of national attention as it was the main focus of the motion picture Erin Brockovich.

Ion exchange (“IX”) absorption is the current preferred method for removal of chromium. Resins recommended for Cr III and Cr VI are basic anion types that are capable of adsorbing chromate and dichromate. U.S. Pat. Nos. 3,885,018 and 3,903,237 describe a process where low concentrations of Cr VI is concentrated by treatment first through a cation exchange zone followed by treatment in an anion exchange zone. IX is a relatively complex operation requiring skilled technicians and corrosive chemicals making it impractical for use in a small POU (point of use) filter. U.S. Pat. No. 4,481,087, describes a dried sorbent comprising FeOOH granules, that are capable of adsorbing chromate or dichromate in concentrations from about 50 mg to about 2 g/liter, far higher than the maximum acceptable concentration.

All documents and publications cited are incorporated herein by reference in their entirety, to the extent they are not inconsistent with the explicit teachings set forth in this disclosure.

### BRIEF SUMMARY OF THE INVENTION

It is an object of the present invention to provide a heavy metal sorbent media, methods of preparing such media and a method for removing heavy metals from aqueous mixtures such as drinking water.

In one embodiment the sorbent components are formed as a non-woven web capable of retaining virus, bacteria and cysts in addition to arsenic and/or chromium.

In another embodiment, the sorbent is in a more dense granular form with resistance to attrition and capable of being used for example: in small filters, such as POU cartridges; in larger beds, such as would be employed in municipal water treatment plants; or as a coagulating agents. Either form of sorbent of the intended invention has improved dynamic absorption performance over the state of the art for arsenic III and V and chromium III and VI. In addition, the granule form has improved resistance to physical degradation and the filter bed is less prone to clogging.

The preferred sorbent is a granule form consisting of iron hydroxide, dispersed with nano alumina fibers that are preferentially prepared by the hydrothermal formation from aluminum hydroxide.

Further objects and advantages of the present invention will become apparent by reference to the following detailed disclosure of the invention and appended drawing.

### BRIEF DESCRIPTION OF THE DRAWING

FIG. 1 is a transmission electron micrograph of a FeOOH/AlOOH/glass sorbent according to the present invention.

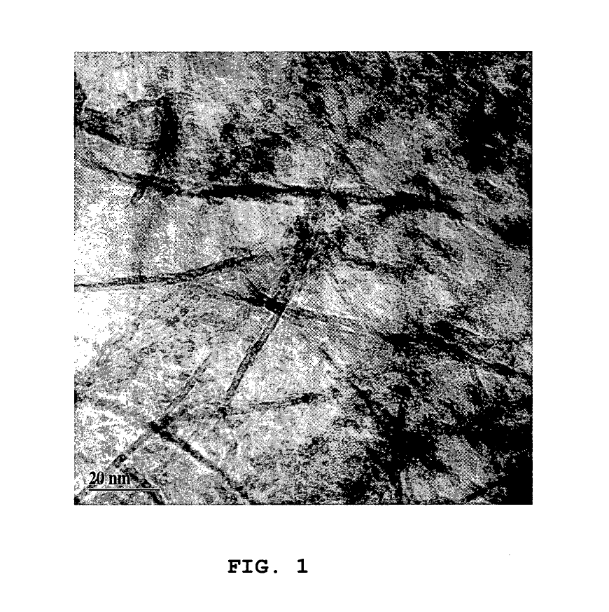

### DETAILED DISCLOSURE OF THE INVENTION

To provide a better understanding of a number of terms used in the specification and claims herein, the following definitions are provided

NanoCeram®, or nano alumina fiber, as used herein, is defined as a discontinuous fiber having a diameter of approximately 2 nanometers. It's composition is primarily boehmite aluminum monohydrate (AlOOH) in an acicular (fibrous) form or in platelet form. The surface area of the NanoCeram ranges between 300-500 m²/g. Helium absorption measurements indicate that it has a pore volume of only about 10% thus indicating that most of its surface area is external rather than requiring absorption via a capillary network typical of AA. Zeta and streaming potential measurements show that NanoCeram is highly electropositive in water and retains electronegative sub-micron particulates including virus and inorganic particles.

The term heavy metals as used herein is defined as any regularly identified heavy metal, such as for example, arsenic, chromium, lead, mercury, cadmium, uranium and transuranium metals. The term also includes its oxides and the various ionic forms of the aforementioned elements.

The term sol as used herein is defined as a fluid colloidal system.

The term metal hydroxide refers to a heavy metal hydroxide that is formed in-situ with the nano alumina fiber as well as oxides, oxyhydroxides, and hydroxyoxides that are formed by dehydration of the hydroxide in formation of the sorbent.

The term substantially moisture-free mixture as used herein is defined as a mixture having less than about five weight percent water.

The nano alumina fiber is produced by hydrothermal digestion of coarse aluminum hydroxide, ground bauxite ore, or by digestion of aluminum powder. The instant invention is a heavy metal sorbent comprised of a composite of nano size alumina fibers which serves as a scaffold for nanosize iron or manganese hydroxide particles. The preferred method of producing the composite begins with the formation of a slurry of nano alumina fibers by the hydrothermal digestion of alumina. The surfaces of the nano alumina fibers are treated with ammonia to create an alkaline surface. The resulting product is mixed with a soluble inorganic salt of iron or manganese to deposit the metal hydroxide over the nano alumina fiber. The process results in a gel that is dried, heat treated, ground, and screened to form erosion resistant granules capable of high dynamic sorption efficiency for heavy metals, for example, such as arsenic III and V and chromium III and VI.

In the alternative, for example, the nano fibers may be incorporated into a non-woven fibrous media that can also sanitize water containing bacteria, virus or cysts. In the non-woven form, the dispersion of the nano alumina fibers occurs by deposition of the nano alumina over an inert fiber scaffolding such as microglass fibers. The result is a highly porous structure similar to paper, where the adsorption sites are completely exposed. While the alumina has some capacity for arsenic and chromium without colloidal iron or manganese hydroxides, the hydroxides dispersed onto the nano alumina fiber enhance the dynamic capacity for both arsenic III and V and chromium VI. The fibrous/granular composite has improved resistance to attrition as compared to other forms of granular iron oxide or hydroxide containing arsenic sorbents.

Following are examples illustrating procedures for practicing the invention. These examples should be construed as to include obvious variations and not limiting. Unless noted otherwise, all solvent mixture proportions are by volume and all percentages are by weight.

### EXAMPLE 1

Preparation of Granular Media

A composite (Alfox 18) of 25 weight percent AlOOH and 75% FeOOH was prepared as follows. Ten grams of aluminum hydroxide, Al(OH)₃ (Aldrich Chemical) was added to 500 mL water contained within an opened 800 mL stainless steel pressure vessel. A solution of 0.2 g sodium hydroxide dissolved in approximately about 50 mL distilled water was added and the reactor was sealed. The mixture was heated to approximately 175° C. with a pressure of 130 psi for 2 hrs. The mixture was cooled to ambient temperature, opened, and 60 mL of approximately 28% ammonium hydroxide solution was added, followed by 58.3 g FeCl₃ 6H₂O (Aldrich Chemical) dissolved in 200-300 mL of water. Excess water was decanted and the residual was filtered. The precipitate was loaded into a metal dish and placed for 5 minutes into a preheated 450° C. oven. After cooling, the material was ground to a smaller fraction and heated in an air oven at 250°C. for 4 hours. The granules were sieved to a −8+50 mesh fraction.

The bulk density of the sorbent is 0.85 g/cc as compared to 0.50 g/cc for the sorbent Bayer E-33 discussed infra. Accordingly the sorbent of the present invention is 1.7 times as dense as the Bayer E-33 and thus a filter cartridge would contain 70% greater weight of sorbent and a significantly higher absorption capacity.

Dynamic Testing

a. Preparation of Test Solutions (Arsenic III and V)

The As V concentrate solution (approximately 5-10 ppm) was prepared by dissolving 10 mg As₂O₅ in 1 liter of distilled water for 2 days. Stock solutions of As(V) were prepared by dilution of the concentrate solution. As(III) concentrate was prepared by first dissolving 0.282 g NaOH in 40 mL water (pH 12), then dissolving 10 mg As₂O₃ in the solution. Four (4) mL of nitric acid (pH=1) was added and the solution was diluted to 1 liter (final pH=5). Stock solutions of As(III) were prepared by the dilution of the concentrate solution.

b. Method of Detection Arsenic

Acustrip arsenic indicator tape, for example, similar to that available from Industrial Test Systems, was used for estimation of the total arsenic in the effluent. The low range indicator product is capable of detecting from as low as 2 ppb to 160 ppb arsenic. The coarse indicator product has a detection limit from about 5 ppb up to about 500 ppb for undiluted solution.

c. Absorption Testing

Alfox 18 was tested vs. Bayer AG Corp Bayoxide E-33 arsenic sorbent. The E-33 was sieved to the same sieve size as the Alfox 18 (−30+50), to yield a more direct comparison of arsenic absorption. A sample (0.15 g) of either sorbent was placed into a tube 3 mm diameter, 1″ high for Alfox 18 and 1.7″ high for E-33, and challenged with either 50 ppb or 300 ppb As V or As III at pH's 6.5 and 8.5. The flow velocity was designed to simulate a 1 gallon/min flow through a 2.5″ diameter 10″ long (8″ bed) cartridge. Testing was terminated when the pressure drop exceeded 15 psi (approximately 1 bar) or when the effluent concentration reached 50% of the challenge concentration at least two consecutive times. We noted that the E-33 sorbent had a greater pressure drop at the beginning of testing as compared to Alfox 18, presumably due to erosion of fine particles. The E-33 bed reached 15 psi pressure drop after 4-8 days of filtering whereas the Alfox 18 didn't reach the 15 psi pressure drop for at least 25 days.

Table 1 compares values for dynamic arsenic adsorption capacity to the 10 ppb limit as well as total arsenic capacity both on a weight and volume basis.

TABLE 1
Dynamic Arsenic Capacity for Granular
Sorbent #18 and Bayoxide E-33

| | | | | Time | | | |
|---|---|---|---|---|---|---|---|
| | | | | to | Capacity | | |
| | | | | reach | to 10 ppb, | | |
| | | | | 1 bar | mg | Capacity, | Capacity, |
| | | Concentration | | ΔP, | As/g | mg As/g | mg As/cc |
| Sorbent | Valence | (ppb) | PH | days | sorbent | sorbent | sorbent |
| Alfox 18 | As (V) | 50 | 6.5 | 24 | 5.3 | 10 | 8.5 |
| | | | 8.5 | >25 | 1.7 | 11.1 | 9.4 |
| | | 300 | 6.5 | TC | 2 | 18.2 | 15.5 |
| | | | 8.5 | TC | 0.4 | 3.1 | 2.6 |
| | As (III) | 50 | 6.5 | >30 | 1.9 | 11 | 9.4 |
| | | | 8.5 | >25 | 2.3 | 10.8 | 9.2 |
| | | 300 | 6.5 | TC | 0.7 | 7.7 | 6.5 |
| | | | 8.5 | TC | 1.0 | 5.9 | 5.0 |
| Bayoxide | As (V) | 50 | 6.5 | 10 | 2.3 | 4.7 | 2.4 |
| E33 | | | 8.5 | TC | >1.1 | 5 | 2.5 |
| | | 300 | 6.5 | 4 | 1.9 | 10 | 5.0 |
| | | | 8.5 | TC | 0.5 | 3.8 | 1.9 |
| | As (III) | 50 | 6.5 | 4 | 0.9 | >0.9^{a} | >0.5 |
| | | | 8.5 | TC | 3.0 | 6.3 | 3.2 |
| | | 300 | 6.5 | TC | 2.5 | 9.1 | 4.6 |
| | | | 8.5 | TC | 1.3 | 6.2 | 3.1 |

Note:
TC - test completed before the pressure drop reached 1 bar value;
^{a}test was terminated because of high pressure drop (>15 psi)

The data on a per unit volume basis indicate that the sorption capacity of Alfox 18 is more than E 33 for any of the test conditions. At 50 ppb As V, one of the most prevalent conditions, the volumetric sorption capacity of Alfox is more than 3.5 times as great as E33.

### EXAMPLE 2

Equilibrium capacity was measured for different sorbents by adding a known amount, initially 3-10 milligrams, to a solution of 1 liter of As III or V (prepared as described in Example 1), and mixing with a magnetic stirrer for 24 hours. After filtration of the solid, the filtrate was analyzed for arsenic. If the measured arsenic content was at or near zero value, the experiment was repeated with a smaller amount of sorbent until a measurable amount of arsenic was found in solution, demonstrating the presence of excess sorbent. The equilibrium capacity was determined by calculation of arsenic absorbed per unit weight of sorbent.

The arsenic capacity of Alfox 18 was compared to Apyron Aquabind MP and Bayer AG Bayoxide E-33 (Table 2). Both materials are manufactured and sold as arsenic sorbents. In addition, both contain some form of iron oxide or hydroxide. Another recent innovation is granular ferric hydroxide (“GFH”), developed at the Technical University of Berlin. Data on its arsenic absorption capacity can be found in EPA REPORT 815-R-00-028, TECHNOLOGIES AND COSTS FOR REMOVAL OF ARSENIC FROM DRINKING WATER, pp. 2-46. (December 2000). These data are included in Table 2. GFH is known to have superior arsenic absorption as compared to AA in adsorbing at a pH above 7.6, and below pH 7 it's performance is comparable. Ibid. A challenge solution identical to that in EPA REPORT 815-R-00-028, TECHNOLOGIES AND COSTS FOR REMOVAL OF ARSENIC FROM DRINKING WATER, pp. 2-46. (December 2000) was prepared and the equilibrium capacity for GFH and Alfox 18 were determined under similar conditions. Upon mixing the E-33 sorbent it was determined that the granule completely disintegrated and became a gel-like substance, thus explaining the premature pressure drop increases noted in Table 1 supra.

TABLE 2
Static Capacity of Granular Samples for As (V)

| | | | Wt (mg) | | | |
|---|---|---|---|---|---|---|
| | | | of | | | |
| | | | granules/ | | | |
| | As | | L of | As, ppb | | |
| | Challenge, | | stock | in | mg As/g | mg As/cc |
| Sorbent | ppb | pH | solution | filtrate | sorbent | sorbent |
| Alfox 18 | 50 | 6.5 | 3 | 20 | 10 | 8.5 |
| | 21 | 7.8 | 1.5 | 12 | 6 | 5.1 |
| Bayoxide | 50 | 6.5 | 3 | 8* | 14 | 7.0 |
| E-33 | | | | | | |
| Apyron | 50 | 6.5 | 10 | 10 | 4 | 2.9 |
| Aquabind | | | | | | |
| MP | | | | | | |
| GFH | 21 | 7.8 | | | 4.5** | *** |

*disintegrated
**EPA REPORT 815-R-00-028 supra.,
*** bulk density values not available

Table 2 indicates that the static volumetric capacity of the Bayoxide E-33 is lower than the Alfox 18. It also has a major deficiency in that it disintegrates prematurely. Alfox 18's capacity is 2.9 times greater than the Aquabind MP as well as being about 33% better than the published [4] values for GFH when compared on a weight basis.

### EXAMPLE 3

Preparation and Testing of Filter Media-

a. Sol-gel method preparation of Alfox 4 (39% AlOOH, 11% FeOOH, 52% microglass)—A slurry of Alfox 4 was prepared as follows: Lauscha B-06-F microglass (2 g) was mixed with 550 mL distilled water in a blender for approximately 2-5 minutes at a high RPM setting. Other mineral fibers such as basalt or silica may be used to produce the non-woven structure. Aluminum powder (0.53 grams) was added, either in the form of nano size particles produced by the electroexplosion of metal wire, (Yavorovsky, N. A., (1996) Izvestiia VUZ. Fizika 4:114-35) or 2 μm and 5 μm granules obtained from Valimet (H-2 and H-5 grade). Ammonium hydroxide (4 mL of approximately 28% solution) was then added. The mixture was heated to 70° C. until reaction ceased (about 10 minutes for the nano size aluminum and 1-2 hours, including ultrasonic mixing for the coarser aluminum). After cooling, an additional 4 mL of 28% ammonium hydroxide was added, followed by 2.0 g FeCl₃-6H₂O dissolved in 20-30 mL of water. Alternatively, 1.8 g of manganese chloride (MnCl₂-4H₂O) (Aldrich Chemical) was added or a mixture of manganese and iron salts of various ratios.

b. Hydrothermal method—(Alfox 14-29% AlOOH, 14% FeOOH, 14% MnOOH, 43% microglass)—A slurry of Alfox 14 was prepared as follows: Lauscha B-06-F microglass (2 g)and aluminum hydroxide (1.7 g), Al(OH)₃ (Aldrich Chemical) was mixed with 550 mL distilled water in a blender for approximately 2-5 minutes at a high RPM setting. The mixture was transferred to an open 800 mL stainless steel pressure vessel. A solution of 0.2 g sodium hydroxide dissolved in approximately about 50 mL distilled water was added and the reactor was sealed. The mixture was heated to approximately 175° C. to produce a pressure of 130 psi and maintained for 2 hrs. The mixture was cooled to ambient temperature, opened, and 4 mL of approximately 28% ammonium hydroxide solution was added, followed by 1.72 g FeCl₃ 6H₂O (Aldrich Chemical) dissolved in 40 mL of water and 1.52 g MnCl₂ 4H₂O (Aldrich Chemical) dissolved in 40 mL of water.

Equilibrium capacity of filter media made via sol-gel and hydrothermal methods showed similar values while tested under static test conditions.

The arsenic absorption capacity of the fibrous media was determined under low flow as a function of pH. A series of tests were performed where at least one liter of challenge solution was passed through sorbent contained by a frit (pore size of approximately 10 microns) within a tube having an ID of 1 cm. The flow velocity could be altered by changing the frit size from coarse (40-60 μ), through medium (10-16 μ), to fine (4.0-5.5 μ). The purpose of a high pressure drop fine frit was to have a space velocity slow enough (approximately 0.1 cm/min) for the solution to dwell for 100+hours during transit through the bed, so that equilibrium adsorption would be approached. Approximately 1.0 mm thick of sorbent “Alfox 14” (29% AlOOH, 14% FeOOH, 14% MnOOH, 43% microglass) was placed on the frit. It was observed that the flow through the sorbents varied by as much as a factor of 3. In order to normalize the data, the flow rates were adjusted by applying differing pressures (from 0.1 to 0.8 bar) on the influent side.

Table 3 presents the adsorption capacity for sorbent #14 at challenge solutions of 50 ppb and 300 ppb of As(III) and As(V) and at pH's of 6.5 and 8.5.

TABLE 3
Arsenic Capacity for Alfox 14 Filter Media

| | | | Equilibrium |
|---|---|---|---|
| | Concentration, | | Capacity, |
| Challenge | ppb | pH | mg As/g sorbent |
| As(III) | 50 | 6.5 | 2.7 |
| | | 8.5 | 1.8 |
| | 300 | 6.5 | 8.3 |
| | | 8.5 | 3.1 |
| As(V) | 50 | 6.5 | 5.3 |
| | | 8.5 | 5.1 |
| | 300 | 6.5 | 7.6 |

The various capacity values for sample 14 (>5.1 mg As/g adsorbent for As(V) at pH 6.5 and 8.5) exceed that for published values of As(V) capacity for GFH (3.2 mg As(V)/g at pH 8.2 and 16 ppb As (V) (see Table 2 Supra). No comparable absorption data have been found on As III capacity for GFH.

### EXAMPLE 4

### Equilibrium Capacity of Various Iron/Manganese Sorbents

Various filter media compositions were prepared and their equilibrium arsenic capacities were measured as described in Example 3. Table 4 illustrates that various compositions of iron and manganese hydroxides, formed in situ with the alumina hydroxide/microglass matrix are effective sorbents for arsenic III and V.

TABLE 4
Static Capacity of Filter Samples for 100 ppb
As (V) and As (III)

| | | | | | | | Equi- |
|---|---|---|---|---|---|---|---|
| | | | | | | | librium |
| | | | | | | | Capacity, |
| Alfox | Filter Media Composition, % | | | | Chal- | | mg As/g |
| Sorbent | AlOOH | FeOOH | MnOOH | Glass | lenge | pH | sorbent |
| 8 | 32 | 20 | 0 | 48 | As (V) | 7.7 | 5.6 |
| | | | | | As (III) | 8.8 | 4.1 |
| 13 | 29 | 0 | 28 | 43 | As (V) | 7.7 | 4.2 |
| | | | | | As (III) | 8.0 | 3.2 |
| 14 | 29 | 14 | 14 | 43 | As (V) | 7.7 | 5.0 |
| | | | | | As (III) | 8.8 | 3.7 |

### EXAMPLE 5

### Bacteria, Virus, Cyst Retention of Arsenic Filter Media

Alfox14 filter media (25 mm diameter) was challenged by a solution containing 1·10¹² latex spheres (30 nanometers in diameter)/mL. The effluent was monitored with a turbidimeter. The latex spheres were used by Hou et al. supra. as a surrogate for virus particles in measuring the efficiency of filters. The flow rate of the challenge solution was 10 mL/min. The media was found to absorb 1.4·10¹³ latex particles/cm² of filter area until detected in the effluent by the turbidimeter. This demonstrates that the filter media, while capable of high capacity for arsenic is also capable of filtering colloidal particles including virus.

### EXAMPLE 6

### Retention of Latex Spheres by Granular Arsenic Sorbent

A sample (1.8 g) of Alfox 18 was placed into a 3 mm diameter, 10″ high tube and challenged with 40 mL of a solution containing 1.2·10⁷ Plaque Forming Units (“PFU”)/mL of bacteriophage MS2 (ATTC, catalog number 155597—B1) with a pH 7.3, at a flow rate of 7 mL/min. This flow rate corresponds to 1 gallon per minute through a 2.5″ diameter cartridge, a size typical of a point of use arsenic filter. The effluent was assayed for MS2 and a retention of 99.5% virus was found for the granular filter under these conditions.

### EXAMPLE 7

The equilibrium chromium VI capacities for Alfox 18 (25 wt % AlOOH, 75% FeOOH) and Alfox 26 (23% AlOOH, 69% FeOOH, 8% MnOOH) were measured at 300 ppb by adding 100 milligrams of sorbent to a 1 liter solution of Cr VI and then mixing with a magnetic stirrer for 65 hours. The Cr VI was prepared by dissolving Cr VI oxide in water. The total chromium content in the supernatant was determined by the 1,5-diphenylcarbohydrazide method, by measuring adsorption of the supernatant at 540 nm with the use of Genesis-10 spectrophotometer. From these data the chromium adsorbed during the 65 hour period was computed. Table 5 summarizes the absorption data demonstrating that Alfox sorbents are sorbents for chromate as well as for dissolved arsenic compounds.

TABLE 5
Static Adsorption Capacity of 300 ppb Cr VI

PH = 6.5

| | Cr VI, ppb | mg CrVI sorbed/g |
|---|---|---|
| Sorbent | in filtrate | sorbent |
| 18 | 21 | 5.6 |
| | 189 | 6.9 |
| 26 | 86 | 2.1 |

### EXAMPLE 8

Utilizing the aforementioned techniques sorbents were produced in the absence of nano alumina fiber. The first was a silica base granular media (25% SiO₂/75% FeOOH). The second was iron hydroxide without silica or alumina nano fibers. The silica sorbent was prepared from amorphous fumed silica (Cab-O-Sil M-5, Cabot Corporation). The 100% FeOOH was prepared using the same procedure as Alfox but eliminating the alumina. This sorbent might be typical of GFH. Both sorbents were sieved to −30+50 mesh fraction and the static capacity of each was determined.

TABLE 6
Static Capacity of Granular Samples for As (V)

| | | | Wt (mg) of | | |
|---|---|---|---|---|---|
| | As | | granules/L | | |
| | Challenge, | | of stock | As, ppb in | mg As/g |
| Sorbent | ppb | PH | solution | filtrate | sorbent |
| Alfox | 50 | 6.5 | 3 | 20 | 10 |
| 18 | | | | | |
| 25% SiO₂/ | 50 | 6.5 | 3 | 20^{a} | 10 |
| FeOOH | | | | | |
| FeOOH | 50 | 6.5 | 3 | 20^{a} | 10 |

Note:
^{a}disintegrated;

All sorbents had the same equilibrium capacity for As V. However, the pure iron hydroxide as well as the silica reinforced hydroxide disintegrated, typical of E-33 as described in Table 1. Accordingly, when present in the sorbent, nano alumina fibers serve to reinforce the sorbent particles and minimize the deaggregation of the granule and clogging of the bed.

Without being held to any particular mechanism, it is believed that the sorbent principally sorbs dissolved heavy metals. However, the electrostatic nature of the nano alumina could provide for a mechanism whereby sub-micron particulates of metal oxides and/or metal particulates are also retained.

Inasmuch as the preceding disclosure presents the best mode devised by the inventor for practicing the invention and is intended to enable one skilled in the pertinent art to carry it out, it is apparent that methods incorporating modifications and variations will be obvious to those skilled in the art. As such, it should not be construed to be limited thereby but should include such aforementioned obvious variations and be limited only by the spirit and scope of the following claims.

1. A heavy metal removal media comprising a mixture of nano alumina fiber; and a second hydroxide containing compound.

2. The heavy metal removal media of claim 1 wherein said heavy metal is selected from the group consisting of arsenic, chromium, mercury, lead, cadmium, uranium and oxides or ions thereof.

3. The heavy metal removal media of claim 2 wherein said heavy metal is arsenic, or an oxide or ion thereof.

4. The heavy metal removal media of claim 2 wherein said heavy metal is chromium, or an oxide or ion thereof.

5. The heavy metal removal media of claim 2 wherein said heavy metal is mercury, or an oxide or ion thereof.

6. The heavy metal removal media of claim 2 wherein said heavy metal is lead, or an oxide or ion thereof.

7. The heavy metal removal media of claim 2 wherein said heavy metal is cadmium, or an oxide or ion thereof.

8. The heavy metal removal media of claim 2 wherein said heavy metal is uranium or an oxide or ion thereof.

9. The heavy metal removal media of claim 1 wherein said second hydroxide containing compound is selected from the group consisting of: ferric hydroxide; manganese hydroxide; ferric oxyhydroxide; manganese oxyhydroxide; ferric hydroxyoxide; manganese hydroxyoxide; ferric oxide; manganese oxide and mixtures thereof.

10. The heavy metal removal media of claim 8 wherein said second compound is ferric hydroxide.

11. The heavy metal removal media of claim 8 wherein said second compound is manganese hydroxide.

12. The heavy metal removal media of claim 8 wherein said second compound is ferric oxyhydroxide.

13. The heavy metal removal media of claim 8 wherein said second compound is manganese oxyhydroxide.

14. The heavy metal removal media of claim 8 wherein said second compound is ferric hydroxyoxide.

15. The heavy metal removal media of claim 8 wherein said second compound is manganese hydroxyoxide.

16. The media of claim 1 wherein said second hydroxide containing compound is present in the mixture in an amount from about 5 weight percent to about 95 weight percent, based on the weight of the moisture-free mixture.

17. The media of claim 16 wherein said second hydroxide containing compound is present in the mixture in an amount from about 25 weight percent to about 75 weight percent, based on the weight of a substantially moisture-free mixture.

18. The media of claim 1 wherein a mineral fiber is added to produce a non-woven fiber filter.

19. The media of claim 18 wherein said mineral fiber is microglass.

20. The media of claim 18 wherein said mineral fiber comprises between about 5 to 50 weight percent based on the weight of a substantially moisture-free mixture.

21. The media of claim 1 wherein the mixture is subjected to calcination at a temperature of between about 200° C. to about 500° C. for a period of about 0.5 to about 8 hours.

22. The media of claim 1 wherein the mixture comprises a non woven fibrous mixture containing a metal hydroxide with an average particle size from between about 0.5 and 100 nanometers.

23. The media of claim 1 wherein the mixture comprises granules having an average particle size of between about 4 and about 400 mesh.

24. The media of claim 1 wherein said nano alumina fibers are produced by the method selected from the group consisting of: hydrothermal digestion of aluminum salts; hydrothermal digestion of alumina hydroxide; and hydrolysis of aluminum powder.

25. The media of claim 24 wherein said nano alumina fibers are produced by the hydrothermal digestion of alumina salts.

26. The media of claim 23 wherein said nano alumina fibers are produced by the hydrothermal digestion of aluminum hydroxide.

27. The media of claim 23 wherein said nano alumina fibers are produced by the hydrolysis of aluminum powder.

28. The media of claim 1 wherein said hydroxide is formed from a salt solution comprises at least one salt selected from the group consisting of; ferric salts; manganese salts; and mixtures thereof.

29. The media of claim 28 wherein said salt solution comprises ferric salt

30. The media of claim 28 wherein said salt solution comprises manganese salts.

31. The media of claim 28 wherein said salt solution comprises a mixture of ferric and manganese salts.

32. A method for preparing a heavy metal removal media comprising the steps of:
producing nano alumina fibers by the digestion of an aluminum source;
producing a slurry of said nano alumina fibers by mixing said fiber with an alkaline solution;
treating said slurry of nano alumina fiber with a salt of iron and/or manganese;
drying the mixture to form the hydroxide;
calcining the mixture to form an absorbent material;
grinding and sieving the absorbent to a granular powder.

33. The method for preparing a heavy metal removal media of claim 32 wherein said media removes at least one heavy metal selected from the group consisting of the arsenic; chromium; mercury; lead; cadmium; uranium and oxides or ions thereof.

34. The method of claim 33 wherein said heavy metal is arsenic or an oxide or ion thereof.

35. The method of claim 33 wherein said heavy metal is chromium or an oxide or ion thereof.

36. The method of claim 33 wherein said heavy metal is mercury or an oxide or ion thereof.

37. The method of claim 33 wherein said heavy metal is lead or an oxide or ion thereof.

38. The method of claim 33 wherein said heavy metal is cadmium or an oxide or ion thereof.

39. The method of claim 33 wherein said heavy metal is uranium or an oxide or ion thereof.

40. The method of claim 32 wherein said aluminum source present is from about 10 weight percent to 95 weight percent, based on the weight of the moisture-free mixture.

41. The method of claim 32 wherein said aluminum source is present in an amount between about 25 weight percent to about 80 weight percent, based on the weight of the moisture-free mixture.

42. The method of claim 32 wherein said aluminum source is selected from the group consisting of aluminum salts and hydroxides of aluminum.

43. The method of claim 32 wherein said aluminum source is aluminum trihydroxide.

44. The method of claim 32 wherein said aluminum source is aluminum powder or flake.

45. The method of claim 32 wherein the hydrothermal reaction of said aluminum source takes place at a temperature between about 150° C. to about 225° C.

46. The method of claim 32 wherein the nano alumina fiber is produced by: digesting aluminum powder having a dimension between about 0.02 and 100 microns with an alkaline solution at a temperature between about 40° C. and 100° C. until the reaction ceases.

47. The method of claim 32 wherein a slurry of mineral fibers, is mixed with said nano alumina;
the slurry is treated with an alkaline solution;
acid salt of iron and/or manganese is added to form the hydroxide and the resulting slurry is wet laid into a filter media to form a non-woven fibrous matrix containing dispersed hydroxides

48. The method of claim 32 wherein said alkaline solution is ammonium hydroxide.

49. A method of removing heavy metals from a solution comprising bringing said solution into contact with a sorbent media comprising a mixture of nano alumina fiber and a second hydroxide containing compound.

50. The method of claim 49 wherein said heavy metal is selected from the group consisting of arsenic; chromium; mercury; lead; cadmium; uranium and oxides or salts thereof.

51. The method of claim 49 wherein said heavy metal is arsenic or an oxide or ion thereof.

52. The method of claim 49 wherein said heavy metal is chromium or an oxide or ion thereof.

53. The method of claim 49 wherein said heavy metal is mercury or an oxide or ion thereof.

54. The method of claim 49 wherein said heavy metal is lead or an oxide or ion thereof.

55. The method of claim 49 wherein said heavy metal is cadmium or an oxide or ion thereof.

56. The method of claim 49 wherein said heavy metal is uranium or an oxide or ion thereof.

57. The method of claim 49 wherein said second hydroxide containing compound is selected from the group consisting of ferric hydroxide; manganese hydroxide; ferric oxyhydroxide; manganese oxyhydroxide; ferric hydroxyoxide; manganese hydroxyoxide; and mixture thereof.

58. The method of claim 57 wherein said second hydroxide containing compound is substantially dehydrated to create an oxide compound.

59. The method of claims 57 wherein said second hydroxide containing compound is ferric hydroxide.

60. The method of claim 57 wherein said second hydroxide containing compound is manganese hydroxide.

61. The method of claim 57 wherein said second hydroxide containing compound is ferric oxyhydroxide.

62. The method of claim 57 wherein said second hydroxide containing compound is manganese oxyhydroxide.

63. The method of claim 57 wherein said second hydroxide containing compound is ferric hydroxyoxide.

64. The method of claim 57 wherein said second hydroxide containing compound is manganese hydroxyoxide.

65. The method of claim 57 wherein said second hydroxide containing compound is present in the mixture in an amount from about 5 weight percent to about 95 weight percent, based on the weight of a substantially moisture-free mixture.

66. The method of claim 65 wherein said second hydroxide containing compound is present in the mixture in an amount from about 25 weight percent to about 75 weight percent based on the weight of a substantially moisture-free mixture.

67. The method of claim 49 wherein a mineral fiber is added to said filter media to produce a non-woven fiber filter.

68. The method of claim 67 wherein said mineral fiber is microglass.

69. The method of claim 67 wherein said mineral fiber comprises between about 5 weight percent and 50 weight percent, based on the weight of a substantially moisture-free mixture.

70. The method of claim 49 wherein the mixture comprises granules having an average particle size of between about 4 mesh and about 400 mesh.

71. The method of claim 49 wherein said nano alumina fibers are produced by the method selected from the group consisting of: hydrothermal digestion of alumina salts; hydrothermal digestion of alumina hydroxide; and hydrolysis of aluminum powder.

72. The method of claim 49 wherein said salt solution comprises at least one salt selected from the group consisting of ferric salts; manganese salts; and mixtures thereof.
